(19) United States
(12) Patent Application Publication
(10) Pub. No.: US 2008/0019524 A1
(43) Pub. Date: Jan. 24, 2008

(54) APPARATUS AND METHOD FOR LOW POWER AES CRYPTOGRAPHIC CIRCUIT FOR EMBEDDED SYSTEM

(76) Inventors: Moo Seop KIM, Daejeon (KR); Sung Ik JUN, Daejeon (KR); Young Sae KIM, Daejeon (KR); Young Soo PARK, Daejeon (KR); Ji Man PARK, Daejeon (KR); Jong Soo JANG, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/758,842

(22) Filed: Jun. 6, 2007

(30) Foreign Application Priority Data
Jun. 29, 2006 (KR) 10-2006-0059845
Sep. 29, 2006 (KR) 10-2006-0096422

(51) Int. Cl. H04L 9/28

(52) U.S. Cl. 380/259

(57) ABSTRACT

Provided are an apparatus and a method for a low power AES cryptographic circuit for an embedded system. The apparatus and method allows each round operation to be performed in an order of an add round operation, a sub byte operation, a shift row operation, and a mix column operation in order to realize a small circuit area by making maximum reuse of designed element modules. When data is input, on the first place, operations are repeated in the above order from a first round to a round right before a last round. During a last round, only an add round key operation and a sub byte operation, and a shift row operation are performed, and then an add round key operation using a secret key is performed. At this point, each operation is performed on data by a 8-bit unit.

### CLAIM OF PRIORITY

This application claims the benefit of Korean Patent Application No. 10-2006-59845 filed on Jun. 29, 2006 and Korean Patent Application No. 10-2006-96422 filed on Sep. 29, 2006 in the Korean Intellectual Property Office, the disclosure of which is incorporated herein by reference.

### BACKGROUND OF THE INVENTION

1. Field of the Invention

The present invention relates to an advanced encryption standard (AES) cryptographic technology, which is a symmetric key encryption algorithm, and more particularly, an apparatus and a method for a low power AES cryptographic circuit for an embedded system that can be realized in a smaller size and operated using low power so that it can be applied to an embedded system used in a wireless network environment.

2. Description of the Related Art

As a digital information society develops and electronic commerce is activated, an encryption technology is considered as a crucial technology for achieving safety and reliability of economic activities, and protecting user privacy in a high-speed Internet network-based society.

Meanwhile, recently, studies on a sensor network meaning connection of sensor nodes having calculation ability and a communication function, a wireless network technology based on the sensor network, and a trusted computing for a mobile platform are in active process. However, unlike a high-speed network environment, the sensor network, a wireless network environment, and the trusted computing for a mobile platform require a low-speed and low power data processing rather than a high-speed data processing due to limitations of a system constituting a network.

Also, the embedded system has a limited computing ability and a small circuit area because of limitation of the system. Despite the system limitations, systems used for an embedded system such as a wireless network include lots of unit modules such as an operating system, one or more sensors, a microcontroller, a communication module, and a peripheral circuit. In addition, as information protection regarding an embedded system for a wireless network system and a personal privacy problem emerge recently, it is required to apply a security module for taking a measure against security threat. Therefore, realization of an embedded system for an efficient wireless network is directed to two problems of how to realize a system using low power and how to efficiently realize a security function.

Lot of studies and publications has been made for security of an embedded system of a wireless network. Particularly, scientists including Perrig have proposed a sensor network encryption protocol (SNEP) as a protocol for providing confidentiality, integrity, and authentication of data in order to safely transmit data on a sensor network. In the SNEP, an AES symmetrical key code is used for safety of a protocol. Besides the SNEP, a variety of security methods that can be used for an embedded system for a wireless network such as a mobile trusted computing is proposed. For these security methods, it is required to design of an efficient low power cryptographic circuit.

FIG. 1 is a flowchart illustrating a general procedure of a symmetrical key type AES cryptographic algorithm among cryptographic algorithms proposed for protection of user's privacy according to a conventional art. Generally, a symmetrical key cryptographic circuit includes a code processing part for performing a cryptographic operation and a key generating part for generating a cryptographic key used for a round operation performed by the code processing part. FIG. 1 illustrates an encrypting process procedure for a declarative sentence having a length of 128 bits.

Referring to FIG. 1, when a declarative sentence having a length of 128 bits is input (S101), an initial round operation for the input declarative sentence is performed (S102). The initial round operation is prescribed such that an XOR-operation is performed using a secret key input for an AES cryptographic operation and the input sentence. A secret key used for the initial round operation can have a length of 128, 192, or 256 bits depending on a use purpose. The number of the round operations performing an AES cryptographic operation can change depending on a key length. For example, in the case where the key length is 128 bits, ten times of round operations are performed.

After the initial round operation, a standard round operation is repeatedly performed a predetermined number of times (e.g., ten times). The standard round operation includes a sub byte operation ByteSub, a shift row operation ShiftRow, a mix column operation MixColumn, and an add round key operation AddRoundKey.

In the sub byte operation ByteSub, an arithmetic operation of dividing data of 128 bytes by a byte (8-bit) unit and replacing the divided data by a predetermined value is performed. For this replacing, an operation block called an S-box is used in an inside. The S-box is designed as a look-up table in a memory or designed as a combination circuit. In the shift row operation ShiftRow, an operation of dividing data of 128 bits that has been replaced by a byte unit by a 32-bit unit to move the divided data is performed. Unlike the sub byte operation, the shift row operation does not replace a data value itself but internally rotates 32-bit data to move a location thereof. In the mix column operation, a vector multiplication operation is performed on 128-bit data, which are results of a shift row operation, within a Galois Field GF (2⁸) field, which is a composite field. The mix column operation has a non-linear operation characteristic. Lastly, in the add round key operation, like the above-described initial round operation (S102), a XOR-operation is performed using 128-bit data and a 128-bit round key by a bit unit. At this point, a round key of each round is calculated through a mathematical operation from a secret key used in the initial round operation. The number of calculated round keys changes depending on a key used. At this point, the sub byte operation and the shift row operation are performed by a 8-bit data unit. Since only a position of data changes in the case of the shift row operation, the shift row operation can be simply realized by moving a position of data and storing the data when the sub byte operation is performed and the data is stored. Therefore, the sub byte operation and the shift row operation can be realized to be performed simultaneously.

Therefore, according to a conventional AES algorithm, a first round operation of total 10 round operations performs the sub byte operation and the shift row operation (S103), performs a mix column operation (S104), an add round key operation (S105) on the initially round-operated data.

Also, from a second round to a ninth round, the sub byte operation and the shift row operation are performed (S106), the mix column operation is performed (S107), and the add round key operation is performed (S108) on add round key-operated data in a previous round.

Also, in a last tenth round, the sub byte operation and the shift row operation are simultaneously performed (S109) and the add round key operation is performed (S110) on a final operated value.

Add round key-operated data in the tenth round is output as coded/decoded data that uses a 128-bit key (s111).

A cryptographic circuit should be realized in a small area and the AES cryptographic algorithm should be designed to operate with low power because of limitations of an embedded system itself so that the AES cryptographic algorithm is applied to the embedded system for a wireless network.

However, an AES cryptographic apparatus and method suitable for an embedded system for a wireless network that satisfies the above characteristics has not been proposed up to now.

### SUMMARY OF THE INVENTION

The present invention has been made to solve the foregoing problems of the prior art and therefore an object of the present invention is to provide an apparatus and a method for a low power AES cryptographic circuit for an embedded system, capable of improving performance and reducing power consumption by reducing a time consumed in performing an AES cryptographic algorithm.

Another object of the invention is to provide an apparatus and a method for a low power AES cryptographic circuit for an embedded system that can be realized even in a small circuit area by making a maximum reuse of designed modules.

According to an aspect of the invention, the invention provides an apparatus for a low power AES cryptographic circuit for an embedded system. The apparatus for a low power AES cryptographic circuit for an embedded system includes: an interface circuit for inputting and outputting data and a control command in cooperation with a general purpose processor; a code processing unit for performing a round operation in an operation order of an add round key operation, a sub byte key operation, a shift row operation, and a mix column operation; a data memory for storing data input through the interface circuit and operation results processed at the code processing unit; a data selecting unit for selecting data input/output to and from the code processing unit and a storing unit; and a control unit for controlling the code processing unit, the storing unit, and the data selecting unit such that a round operation of a set round is repeatedly performed on data input from the interface circuit, and an add round key operation is performed on a shift row-operated result value and a secret key during a last round.

According to another aspect of the invention for realizing the object, there is provided a method for a low power AES cryptographic circuit for an embedded system, the method including: performing operations on data to be encrypted in an order of an add round key operation, a sub byte operation, a shift row operation, and a mix column operation; performing operations on a result of a mix column operation of a previous round in an order of the add round key operation, the sub byte operation, and the shift row operation; after the performing of the operations on the result of the mix column operation, checking whether a current round is a last round; when the current round is not the last round as a result of the checking, performing operations again starting from the performing of the operations on the result of the mix column operation, after performing a mix column operation on a result of the performing of the operations on the result of the mix column operation; when the current round is the last round as a result of the checking, performing an add round key operation that uses a secret key on a result of the performing of the operations on the result of the mix column operation; and outputting, as encryption data, a result value of the performing of the add round key operation that uses the secret key.

According to an embodiment of the invention, an apparatus and a method for an ASE cryptographic circuit can be used as a cryptographic technology for protecting a user's privacy, and providing authentication and data integrity in an embedded system for a wireless network that requires a low power/small area cryptographic technology such as a radio frequency identification (RFID) system or a center network and a trusted computing for a mobile platform.

Particularly, according to an embodiment of the invention, an apparatus and a method for an ASE cryptographic circuit process, by a 8-bit (one byte) unit, all data processed at a code processing unit in order to realize low power consumption. Also, the apparatus and method adopts an efficient design of an operation module and makes a maximum use of designed modules in order to prevent unnecessary power consumption with consideration of an environment to which a low power AES cryptographic circuit is applied.

In the case where an operation is performed by a byte unit as described above, an operation of a byte unit should be performed over sixteen times in order to process 128-bit data, so that an operating speed reduces. On the other hand, an apparatus and a method for an ASE cryptographic circuit according to the invention solves this operation speed reduction problem and provides a fast operating speed with low power by reducing the number of times of operations.

An apparatus and a method for an ASE cryptographic circuit according to the invention change a code processing order in order to increase an efficiency of an operation to allow an optimized operation to be performed, and allow a circuit to be shared by a code processing unit and a key generating unit. Particularly, an F function designed in the present invention uses only one S-box and optimizes a design using only a data selector and an XOR circuit. Also, a control register for storing control commands performed by an AES cryptographic circuit, for efficient driving of devices, and a control circuit for controlling a cryptographic operation in response to a command set in the control register are used.

An apparatus and a method for an ASE cryptographic circuit according to the invention applies a clock signal only at a point where a value of a register storing data changes in order to minimize power consumed by a circuit block that does not process data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart illustrating a conventional AES cryptographic algorithm;

FIG. 2 is a basic conceptual flowchart of an AES cryptographic algorithm according to the present invention;

FIG. 3 is a flowchart of an AES cryptographic algorithm according to the present invention;

FIG. 4 is a block diagram illustrating a basic construction of an apparatus of a low power AES cryptographic circuit according to the present invention;

FIG. 5 is a circuit diagram of an apparatus of a low power AES cryptographic circuit according to an embodiment of the present invention;

FIG. 6 is a data flowchart explaining a code operating process at the apparatus of the low power AES cryptographic circuit of FIG. 5; and

FIG. 7 is a data flowchart explaining a mix column operation process and a round key generating process at the apparatus of the low power AES cryptographic circuit of FIG. 5.

### DETAILED DESCRIPTION OF THE PREFERRED EMBODIMENT

Certain or exemplary embodiments of the present invention will now be described in detail with reference to the accompanying drawings. In the description of the present invention, detailed explanations of known functions or constructions will be omitted in the case where they unnecessarily obscure the sprite of the present invention.

It should be noted that like reference numerals in the drawings denote like elements though they appear on different drawings.

Since the number of times of round operations increases as a key length increases but a procedure of the operation performed during a round does not change, an overall operation will be described below using a key length of 128 bit for an example. However, the below description can be directly applied to cases where key lengths of 192 bit and 256 bit are used.

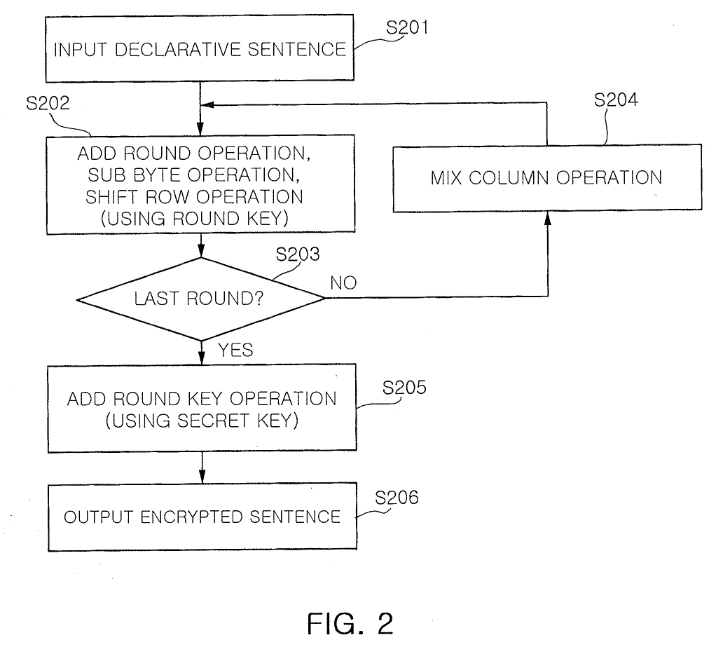

FIG. 2 is a basic conceptual flowchart of an AES cryptographic algorithm according to the present invention.

The inventor of the present invention has analyzed characteristics of each operation process of an AES cryptographic algorithm in order to realize an apparatus and a method of a low power and small area AES cryptographic circuit for an embedded system. The analysis has shown that an order of operations on the whole is not important because the add round key operation, the sub byte operation, and the shift row operation are linearly performed by a 8-bit unit when the algorithm is performed.

Therefore, the present invention reduces the number of times of operations to improve an operating speed by allowing all of the above-described add round key operation, sub byte operation, and shift row operation to be performed during one clock cycle.

A method for an ASE cryptographic circuit according to the present invention will be described in detail with reference to FIG. 2.

Referring to FIG. 2, the method removes a conventional initial round operation process (S102), and directly performs a round operation that uses a round key. Each round operation is performed in an order of an add round key operation→a sub byte operation→a shift row operation→a mix column operation. At this point, the add round key operation, the sub byte operation, and the shift row operation are incorporated to reduce the number of times of operations by one.

In detail, when a declarative sentence to be encrypted is input (S201), the add round key operation, the sub byte operation, and the shift row operation are performed using a first round key on the input declarative sentence (s202).

Since the first round key is not a last round key, the mix column operation is performed (S204) on data resulted from the operation performed in the operation S202.

One round operation is completed by the two operations S202 and S204.

Subsequently, the two operations S202 and S204 are repeatedly performed during all rounds except the last round to perform the add round key operation, the sub byte operation, and the shift row operation on result data of the mix column operation of a previous round, and then perform a mix column operation on a result of the shift row operation.

Also, during the last round, the add round key operation, the sub byte operation, and the shift row operation are performed on data resulted from the mix column operation in the operation S202, and then an operation S205 is performed without the mix column operation, so that an add round key operation that uses a secret key is performed on data resulted from the shift row operation.

The operation S205 is an operation process corresponding to the conventional initial round operation process S102, and is referred to as a last round operation hereinafter.

Also, an operation result of the last round operation S205 is output as an encrypted sentence (S206).

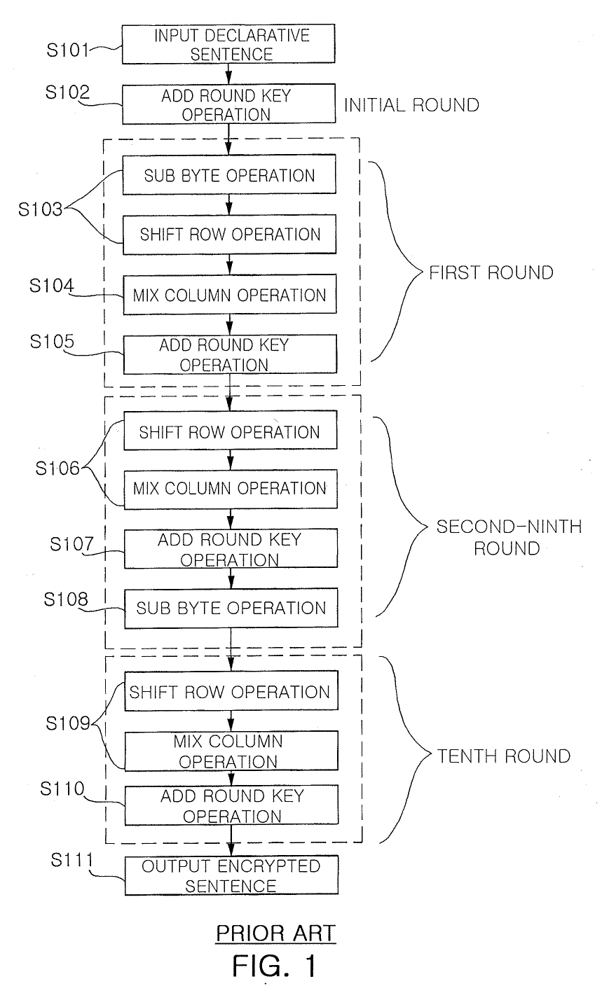

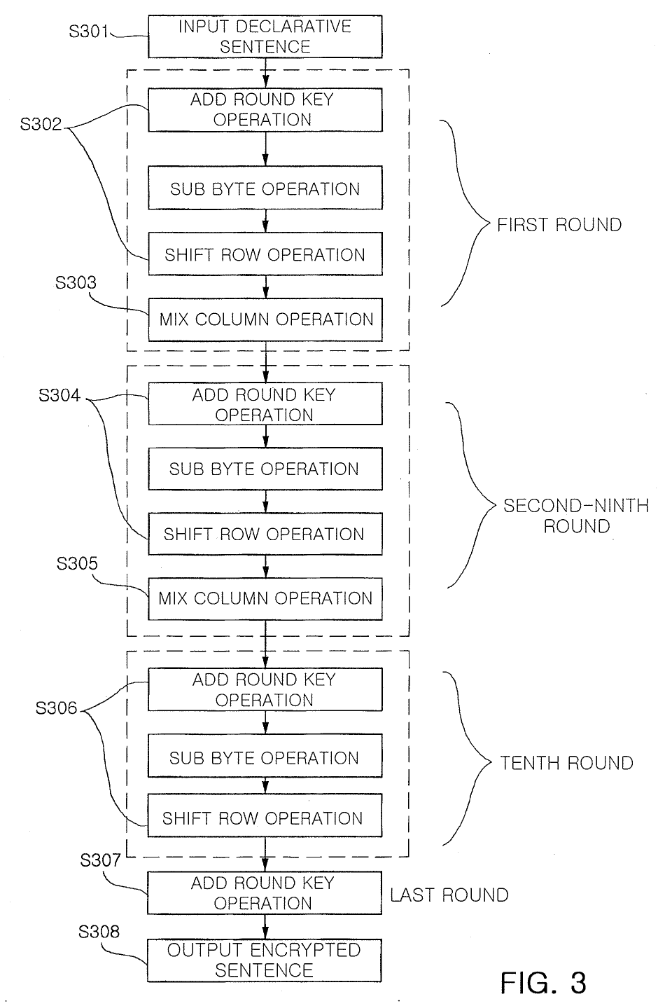

FIG. 3 is a flowchart illustrating in detail an AES cryptographic process according to the present invention in the case where a 128-bit code key is used. Characteristics of the method for the AES cryptographic circuit according to the present invention can be clearly understood by comparing FIG. 3 with the flowchart of FIG. 1 illustrating the conventional cryptographic method.

Referring to FIG. 3, when a declarative sentence to be encrypted is input, an add round key operation, a sub byte operation, a shift row operation that use a first round key generated from a secret key by key scheduling are performed on the input declarative sentence (S302). Also, a mix column operation is performed on a result of the shift row operation (S303). A first round is completed by the two operations S302 and S303.

Next, a second round operation-a ninth round operation are sequentially performed. The second to ninth round operation processes include an operation (S304) of performing an add round operation adding a round key to a result of a mix column operation of a previous round, a sub byte operation, and a shift row operation, and a mix column operation (S305) performed on data resulted from the shift row operation.

Also, during a tenth round, an add round key operation adding an operation result of a ninth round to a key of the tenth round is performed. Subsequently, a sub byte operation and a shift row operation are performed on the result of the add round key operation (S306).

After that, a last round operation adding a secret key that has been used in generating the round key to an operation result of the tenth round is performed (S307).

Result data of the last round operation S307 is output as encryption data (S308).

The add round key operation, the sub byte operation, and the shift row operation are simultaneously performed during one clock in the operations S302, S304, and S306.

In addition, the operations S302-S307 are performed by a 8-bit unit.

According to the present invention, each round operation is defined using two operations. The two operations include one operation consisting of an add round key operation, a sub byte operation, and a shift row operation, and another operation of performing a mix column operation. Therefore, the present invention can reduce one operation process compared to the conventional AES cryptographic algorithm. Particularly, in the case where an operation is performed by a 8-bit unit, at least sixteen times of operations are required to perform one round, so that at least sixteen times of operation clocks can be reduced per round. In more detail, in the case where a 128 bit-secret key is used and an operation is performed by a 8-bit unit, at least ten times of round operations are required and sixteen times of repeated operations are required per round. Therefore, according to the present invention, the operation clocks can be reduced by one clock every round, so that total 160 clocks can be reduced and thus low power is realized and encrypting speed reduction is prevented.

In addition, according to the method for the AES cryptographic circuit according to the present invention, an operation of performing an add round key operation that uses a secret key should be performed (S308) after a last round is performed. This is simply a last change of an operation order of the initial round operation S102 compared to the conventional algorithm, which does not increase the number of clocks consumed for performing an entire operation.

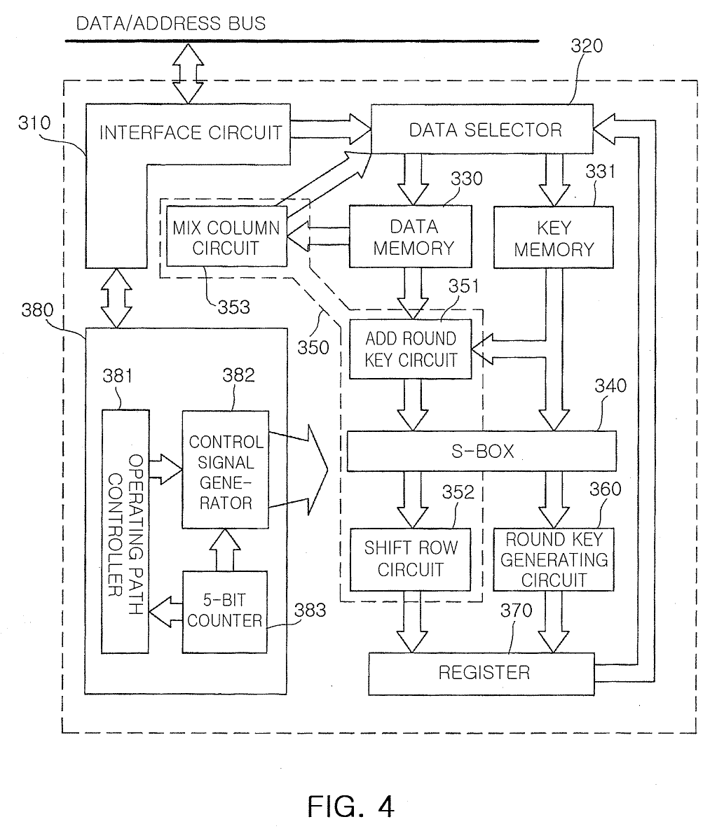

FIG. 4 is a block diagram illustrating a basic construction of an apparatus of a low power AES cryptographic circuit according to the present invention. In FIG. 4, a reference numeral 310 is an interface circuit, 320 is a data memory, 331 is a key memory, 340 is an S-box, 351 is an add round key circuit, 352 is shift row circuit, 353 is a mix column circuit, 360 is a round key generating circuit, 370 is a register, and 380 is a control circuit. The add round key circuit 351, the shift row circuit 352, the mix column circuit 353, and S-box 340 constitute a code processing circuit. The S-box 340 and the round key generating circuit 360 constitutes a key generating unit.

The interface circuit 310 connects a microprocessor (not shown) generally used for a low power embedded system with the apparatus for the AES cryptographic circuit according to the present invention to deliver data and commands between the microprocessor and the apparatus for the AES cryptographic circuit. In more detail, the interface circuit 310 analyzes data or commands transmitted from the microprocessor, stores the data in a control register (not shown) in the inside when the commands are commands to be processed by the apparatus of the AES cryptographic circuit according to the present invention, stores the data in the data memory 330 when the data is data on which an encrypting operation is to be performed, and stores the data in the key memory 431 when the data is a key value (a secret key) used for an encrypting operation.

A control command stored in the interface circuit 310 is read by a control circuit 380 and used for controlling the apparatus for the AES cryptographic circuit. A path set command of data required for generating an encrypting operation or a round key is delivered from a microprocessor, stored in a control register of the interface circuit 310, read by the control circuit 380, and used for a path of data so that an operation according to the method for the AES cryptographic circuit can be performed. The bits of the control register use values defined in advance for each bit in order to control an operation of the apparatus for a low power AES cryptographic circuit.

The data selector 320 selects a path in order to store data and key values applied via the interface circuit 310 from the microprocessor in the data memory 330 and the key memory 331. In more detail, the data memory 330 stores data to be initially input from the microprocessor, and intermediate result values generated while an encrypting operation is performed. The key memory 331 stores a secret key value initially input from the microprocessor, and a round key value generated from the secret key required for performing each round operation. Therefore, the data selector 320 selects a path of data in order to prevent collision of data input to the data memory 330 and the key memory 331, and efficiently perform an operation. At this point, a control signal for the data selector 320 to select a path is provided from the control circuit 380.

The data memory 330 is used for three general purposes. First, the data memory 30 is designed for storing data on which an encrypting operation input via the interface circuit 310 is to be performed. At this point, since the data on which the encrypting operation is to be performed is transmitted from the microprocessor, the control circuit 380 should generate a series of commands for storing data in order to allow the data to be stored in the data memory 330. Second, the data memory 330 sequentially stores intermediate values of respective round operations during the encrypting operation. When a round operation performing an AES encrypting operation is ended, a result value of the AES encrypting operation is stored in the data memory 330. Last, after the encrypting operation is ended, the data memory 330 is used as a storage device for storing result data to be transmitted to a general purpose processor. At this point, the result data stored in the data memory 330 are sequentially transmitted to a bus via the interface circuit 310. A control signal for this is supplied from the control circuit 380.

To realize an apparatus for a lower power AES cryptographic circuit, designing a low power memory occupying a largest area and continuously storing results of an operation is most important. For this purpose, the present invention uses a single-port memory that uses 8-bit registers as the data memory 330. That is, the present invention reduces power consumption of the registers constituting the memory by designing such that the data memory 330 including the registers of a 8-bit unit outputs only register data of a designated address and a clock signal is not applied to the other registers because the other registers have nothing to do with an operation.

The key memory 331 stores a secret key required for an encrypting operation. The stored secret key is used for a last round operation S307 during the algorithm of FIG. 3, and also used for generating a round key required for performing a round operation. Also, the round keys generated from the secret key are also sequentially stored in the key memory 331.

The control circuit 380 supplies a control signal for reading the secret key or the round key stored in the key memory 331 and designating orders in which the keys are supplied to the code processing circuit 350.

Like the data memory 330, the key memory 331 is also designed to have low power consumption using the 8-bit registers.

The S-box 340 is a crucial part in performing an AES encrypting operation and is used for performing a sub byte operation during a round operation. Also, the S-box 340 is also used for generating a round key for performing a round operation.

The S-box 340 can be formed using a look-up table through a memory or can be realized using a combination circuit. The present invention realizes the S-box 340 using a combination circuit, thereby achieving a smaller area. In the S-box using the combination circuit, when data is applied to the S-box, a switching operation always occurs and consumes power. In the case where the S-box is shared in performing a round operation and generating a round key, the S-box consumes power for nearly most of an AES code processing time, resulting in an undesired increase in power consumption. Therefore, to prevent this undesired power consumption, the present invention uses 8-bit registers inside the S-box to allow switching is generated at a combination circuit only when data changes. In addition, the present invention consumes power only when data actually changes by allowing a clock signal not to be applied to the registers used for the S-box when data is not applied to the registers. By doing so, power consumption at the S-box 340 can be remarkably reduced.

In the apparatus for the AES cryptographic circuit, the code processing circuit 350 performing an encrypting operation on data includes an add round key circuit 351, an S-box 340, a shift row circuit 352, and a mix column circuit 353.

The add round key circuit 351 is a block for performing an XOR operation on a round key or a secret key and data. The add round key circuit 351 is formed using a 8-bit XOR circuit to meet low power design and repeatedly performs an operation on input data by a 8-bit unit

The shift row circuit 352 performs a location movement of an output data of the S-box 340. In more detail, the shift row circuit 352 can be simply realized by predicting an order in which results obtained from a 8-bit operation at the S-box 340 are stored in a memory and inputting the order. In this case, data stored in the memory should be read in advance and an operation should be performed on the data before a result of a round operation currently being calculated is stored in the memory. Otherwise, data to be performed in the future changes and a result different from an original result may be output. For this purpose, a performance result of the S-box 340 is stored in a 8-bit register 370, and data stored in the register 370 is read so that a shift row operation is performed on the read data and a converted result is stored. A final value stored in the register 370 is stored in the data memory 330 by the data selector 320.

A series of operation processes by the add round key circuit 351, the S-box 340, and the shift row circuit 352 is repeatedly performed while one round operation is completely performed. That is, operation results of the add round key circuit 351, the S-box 340, and the shift row circuit 352 are stored in the register 370. Memory data of a position in which a result is to be stored is read from the data memory 330, and an operation is performed on the memory data. While the operation is performed, data on which an operation has been performed previously and stored in the register 370 is stored in the data memory 330. The above-descried process is repeatedly performed over sixteen times. When the sixteen times of operations are completed, the operations S302, S304, and S306 of FIG. 3 are completed.

The mix column circuit 353 performs a mix column operation during a round operation process of an AES cryptographic algorithm. Generally, the mix column operation consumes most time during an AES round operation. In the present invention, the mix column circuit 353 is realized using a 32-bit shift register and a 8-bit XOR circuit. For realization of an efficient performance of an operation and a low power AES cryptographic circuit, the 32-bit shift register is used to prevent an XOR circuit from performing an unnecessary switching operation.

The round key generating circuit 360 generates a round key in cooperation with the S-box 340. The round key is required every round during a round operation performed at the code processing circuit 350. In more detail, generally, an AES cryptographic algorithm generates a round key through key extension using an input secret key. The present invention has used a method of sequentially performing extension operations by a 8-bit unit. At this point, an S-box operation used in the method is the S-box 340 used by the code processing circuit 350. Since the S-box 340 is not used while a mix column operation corresponding to the operations S303 and S305 of a round operation is performed, an operation for generating the round key uses the S-box 340 for this time period. That is, the mix column circuit 353 generates a round key of a next round using the S-box 340 not used during the operations S303 and S305 of each round operation. A round key generating operation of the apparatus of the AES cryptographic circuit according to the present invention will be described later in more detail.

The register 370 is formed with 8 bits to store an intermediate result to be stored in the data memory 330 while each round operation is performed. While the mix column circuit 353 performs a mix column operation, the register 370 stores an intermediate value that is generated by the round key generating circuit 360 and stored in the key memory 331. A control signal for allowing data to be stored in the register 370 is applied from the control circuit 380.

The control circuit 380 controls an order of operations of the above-descried elements for performing an encrypting operation and generating a round key and a data flow in the apparatus for the AES cryptographic circuit. The control circuit 380 moves along a state transition designated in advance for each operation in order to sequentially generate control signals suitable for operations performed by the apparatus for the AES cryptographic circuit. That is, in case of a data encrypting operation, a state degree for which an encrypting operation is to be performed is designated in advance and operations are sequentially performed. Also, in case of a decoding operation, operations are performed according to a procedure designated in advance. In addition, to control an operation of the apparatus for the AES cryptographic circuit, a state flowchart should be defined to process data input, data output, a control command input, input/output of key data, a data encrypting operation, a data decoding operation, and interrupt occurrence. The present invention should be designed such that transition between these states can be performed when needed. For example, when an encrypting operation is performed and the operation is completed, the states should make a transition to an interrupt occurrence state to generate an interrupt representing an end of the operation.

The control circuit 380 controls input/output of data via the interface circuit 310, and examines addresses of input data to discriminate whether a value applied to the interface circuit 310 is data or a control command.

Also, the control circuit 380 controls differently depending on a kind of an operation performed at the apparatus for the AES cryptographic circuit. The kind of the operation to be performed at the apparatus for the AES cryptographic circuit is set by a control command transmitted from the microcomputer of an embedded system to the apparatus for the AES cryptographic circuit. In more detail, the control circuit 380 examines an address of data input via the interface circuit 310. When the address of the data is a control command as a result of the examination, the control circuit 380 performs a state transition so that input data is stored in a control register within the interface circuit 310. The control circuit 380 examines a control command stored in the control register of the interface circuit 310 to recognize the kind of an operation to be performed at the apparatus for the AES cryptographic circuit, and starts to make a state transition corresponding to the operation to be performed.

Also, the control circuit 380 reads data required for performing, at the code processing circuit 350, an encrypting operation, and controls an operation of the data memory 330 in order to store intermediate values. The control circuit 380 controls a location of data to be read from the data memory 330 and an order in which the data are read. Also, the control circuit 380 controls on the whole a process for storing orders in which encrypting operations are performed y the code processing circuit 350 and a process for storing operation results.

Particularly, the control circuit 380 controls an overall operation of generating a round key. That is, the control circuit 380 stores key data (secret key) in the key memory 331, controls an overall operation of extending the key data stored in the key memory 331, and generates a necessary control signal. Also, the control circuit 380 stores the extended key value in the key memory 331, controls the round key generating circuit 360 to generate a round key using the data stored in the key memory 331, and controls processes of storing the generated round key in the key memory 331 again. Also, the control circuit 380 generates a control signal that allows round keys stored in the key memory 331 are read by a byte unit and used for an encrypting operation, and supplies the control signal to the code processing circuit 350.

The generating of the control signal at the control circuit 380 is performed by a control signal generator 382 located inside the control circuit 380. The control circuit 380 uses an operation path controller 381 in order to perform a state transition. The operation path controller 381 requires a device that can examine that a state reaches a predetermined point in order to change a state path from a condition or a state such as a predetermined point and time. A 5-bit counter 383 inside the control circuit 380 performs this function.

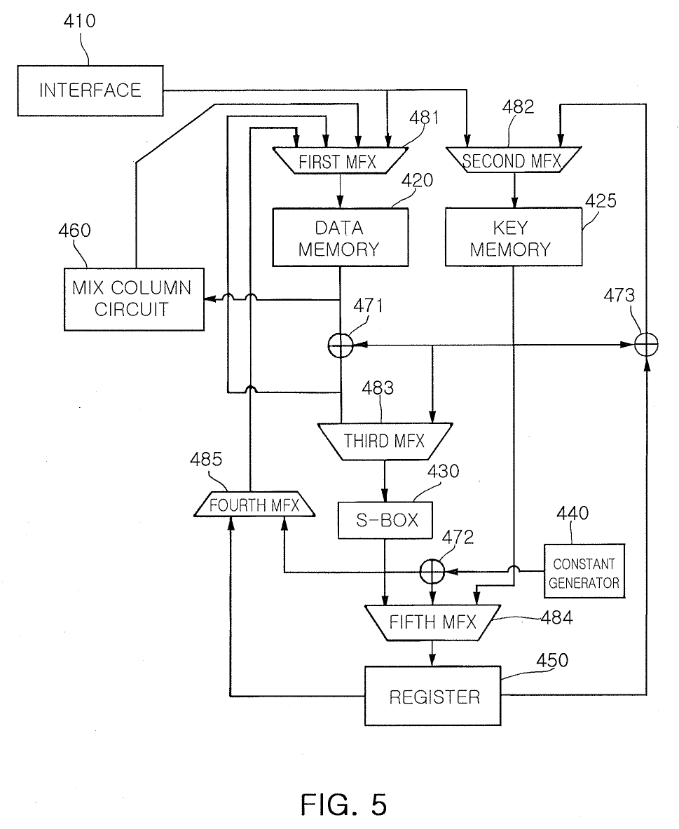

FIG. 5 is a circuit diagram of an apparatus of a low power AES cryptographic circuit according to an embodiment of the present invention. A portion of the control circuit 380 has been excluded in FIG. 5.

The interface circuit 410, the data memory 420, the key memory 425, the S-box 430, the register 450, and the mix column circuit 460 of FIG. 5 correspond to the interface circuit 310, the data memory 330, the key memory 331, the S-box 340, the register 370, and the mix column circuit 353 of FIG. 4.

The data selector 320 includes a first data selector 481 and a second data selector 482.

The first data selector 481 selectively provides data to be stored in the data memory 420. As described above, the data stored in the data memory 420 are input data applied via the interface circuit 410, and the values generated during a round operation of the apparatus for the AES cryptographic circuit. The first data selector 481 selects the data for each operation in response to a control signal applied from the control circuit 380, and applies the selected data to the data memory 420.

The second data selector 482 selectively provides data to be stored in the key memory 425. As described above, the key memory 425 are key data applied via the interface circuit 410 and round key data generated resulted from performance of a round key operation. The second data selector 482 selectively applies two data to the key memory 425 for each operation of the apparatus for the AES cryptographic circuit in response to a control signal applied from the control circuit 380.

In addition, the apparatus for the AES cryptographic circuit further includes a third data selector 483 in order to selectively provide data applied to the S-box 430 depending on whether an operation is an encrypting operation or a round key generating operation. As described above, the S-box 430 is used for both a round operation for the AES encrypting operation and an operation for generating a round key. Therefore, the third data selector 483 selects data applied to the S-box 430 depending on whether an operation is an encrypting operation or a round key generating operation. The third data selector 483 selectively operates using a signal applied from the control circuit 380.

In addition, the apparatus for the AES cryptographic circuit further includes a fourth data selector 484. The fourth data selector 484 selects data input to an 8-bit register 450. As described above, the register 450 is used for storing an intermediate value before storing a value in the data memory 420 during a round operation, or temporarily storing an intermediate value during a round key operation before storing the intermediate value in the key memory 425. The fourth data selector 484 selectively applies a value stored in the key memory 425, a result value of the S-box 430, and result values of the second XOR circuit 472 in response to a selection signal from the control circuit 380.

In addition, the apparatus for the AES cryptographic circuit further includes a fifth data selector 485. The fifth data selector 485 is used for selectively storing intermediate value generated during a round operation in the data memory 420. A value stored in the register 450 during a round operation can be stored in the data memory 420, or an output of the S-box 430 can be directly stored in the data memory 420. In order to selectively use this result value, the fifth data selector 485 operates in response to a control signal from the control circuit 380 and selectively applies an output of the register 450 or the S-box 430 to the first data selector 481.

The first XOR circuit 471 corresponds to the add round key circuit 351 described in FIG. 4. Since the add round key circuit 351 is realized using an 8-bit XOR circuit 471 as described above, a separate data storing circuit is not required, and a time consumed for performing an operation is short. Therefore, the first XOR circuit 471 can be used for reducing a time of performing an AES encrypting operation by allowing the first XOR circuit 471 to be performed before a sub byte operation. In this case, data input to the XOR circuit 471 should be sequentially read from the data memory 420 and the key memory 425 with consideration of a sub byte operation and a shift row operation subsequently performed. For this purpose, addresses applied to the data memory 420 and the key memory 425 should be calculated in advance so that data are not erroneously read. The control circuit 380 calculates the addresses used for reading data and applies the calculated addresses to the memories 420 and 425.

Also, a second XOR circuit 472, a third XOR circuit 473, and a constant generator 440 constitute the round key generating circuit 360 described in FIG. 4.

Generally, an AES encrypting algorithm uses a constant separately defined for calculation of a key that is calculated every round during around key generating process. The constant generator 440 provides a round constant defined by the AES encrypting algorithm, for generation of a round key, and includes a simple shift operation and a register.

The second XOR circuit 472 is an 8-bit XOR operator, and performs an XOR operation on an output of the S-box 430 and an output of the constant generator 440 during a round key generating process. Since the second XOR circuit 472 should generate a round key required for an operation every round, an operation of the second XOR circuit 472 should be performed one time every round to generate a round key to be used next.

The third XOR circuit 473 is an 8-bit XOR operator, and performs an XOR operation on key data stored in the register 450 and key data stored in the key memory 425 during a round key generating process. In the AES encrypting algorithm, an XOR operation needs to be performed on two 8-bit data stored in the key memory 425 to generate a round key. One data stored in the key memory 425 is stored in advance in the register 450 through the fourth data selector 484, and the third XOR circuit 473 performs an XOR operation on secondly read data and the data stored in the register 450, and then the resulting data is stored in the key memory 425 again.

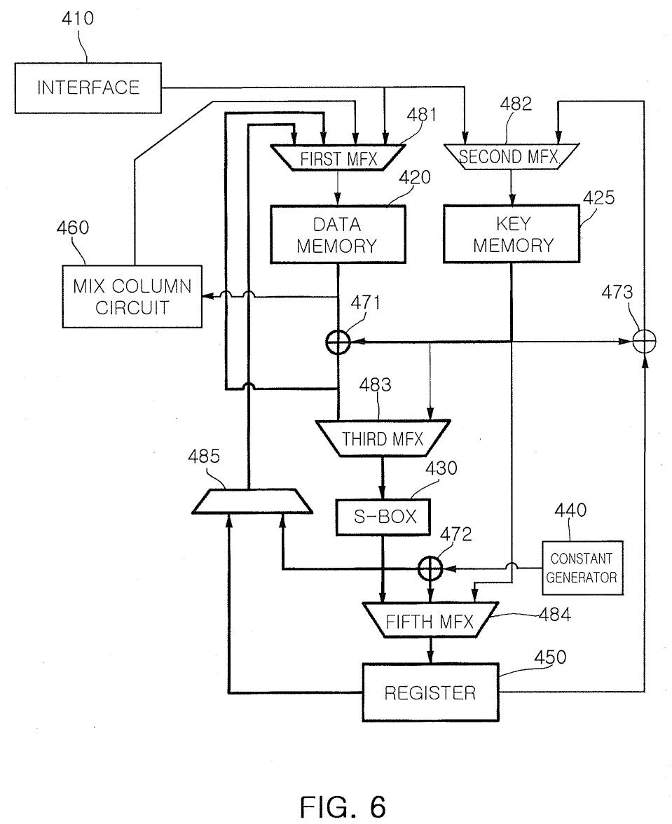

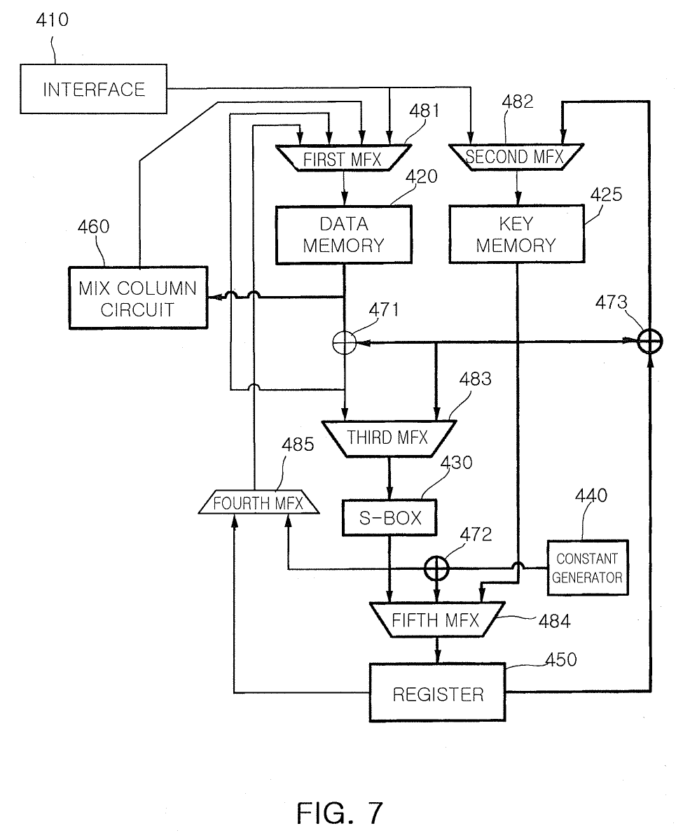

Subsequently, an operation of the apparatus for the AES cryptographic circuit shown in FIG. 5 will be described with reference to FIGS. 6 and 7.

FIG. 6 is a data flow for performing processes S302, S304, and S306 of an add round key operation, a sub byte operation, and a shift row operation during a round operation at the apparatus of the AES cryptographic circuit of FIG. 5.

Referring to FIG. 6, a round operation at the apparatus of the AES cryptographic circuit starts from an add round key operation performing calculation by an 8-bit unit.

For the add round key operation, data are read by an 8-bit unit from the data memory 420 and the key memory 425 and input to the first XOR circuit 471, and subsequently, the first XOR circuit 471 performs an XOR operation on the input two data.

When a round is not final, the 8-bit XOR operation result of the first XOR circuit 471 is applied to the third data selector 483 to perform a sub byte operation. On the other hand, when the round is final, the 8-bit XOR operation result is applied to the first data selector 481.

During a round operation, the third data selector 483 a result value of the first XOR circuit 471 to the S-box 430. The S-box performs a sub byte operation on input data (the applied result value), and a result thereof is stored in the register 450 for storing an intermediate result through the fourth data selector 484. Also, the result value of the S-box 430 is applied to the fifth data selector 485 so that the result value is directly stored in the data memory 420 in the case where a location movement is not generated during a shift row operation.

The register 450 maintains a result value of the S-box 430 and outputs the result value to the fifth data selector 485 so that the result value is stored in the data memory 420 at a point where a next 8-bit data is processed. During operations of storing and outputting the data (value) in the register 450, a location movement of a result value of the S-box 430 is generated, and a shift row operation is performed.

The fifth data selector 485 provides one of an output of the S-box 430 and an output of the register 450 to the first data selector 481. The first data selector 481 selectively applies output values of a round operation to the data memory 420. The data memory 420 stores a result of a round operation in a designated space in response to a control signal and a memory address provided from the control circuit 480 during the round operation.

These operations are repeatedly performed by an 8-bit unit until 128 bit data are completely processed, and results thereof are sequentially stored in the data memory 420. That is, the above-described operations are repeated sixteen times, so that result values of operations S302, S304, and S306 during one round operation are stored in the data memory 420.

After that, mix column operations S303 and S305 are performed on the result value stored in the data memory 420. At this point, a round key generation for a next round, that uses the S-box not used during the mix column operations is performed. Since the mix column operation does not use key data, the mix column operation can simultaneously perform an operation of generating a round key.

FIG. 7 illustrates paths of a mix column operation process and a round key generating process at the apparatus of the AES cryptographic circuit of FIG. 5.

That is, when the add round key, the sub byte, and the shift row operation result of each round stored in the description of FIG. 6 are stored in the data memory 420, the mix column circuit 460 reads result values stored in the data memory 420 to perform a mix column operation thereon.

The mix column circuit 460 includes a 32-bit shift register and XOR circuits. The shift register receives result data by a 8-bit unit from the data memory 420. When a 32-bit is filled with result data, the mix column circuit 460 performs a mix column operation, moving a location by 8 bits. Results of the mix column operation obtained while the mix column circuit 460 moves four times are stored in the data memory 420 via the first data selector 481.

A round key generation is performed simultaneously with the mix column operation.

That is, during a clock cycle in which the mix column circuit 460 operates, the control circuit 380 reads key data by 8 bits from the key memory 425 depending on a predetermined state degree to generate a round key.

At this point, in the case where an initial round key is generated, the data read from the key memory 425 is applied to the S-box 430 via the third data selector 483. The second XOR circuit 472 performs an XOR operation on an output of the S-box 430 and an output of the constant generator 440. The XOR-operated data is stored in the register 450. The third XOR circuit 473 performs an XOR operation on a next output of the key memory 425 and the data stored in the register 450. The XOR-operated data is stored in the key memory 425 via the second data selector 482.

Since an S-box operation is not performed and only an XOR operation on key data is required during a next round key generation, the fourth data selector 484 directly applies a result value read from the key memory 425 to the register 450 and stores the result value in the register 450. The third XOR circuit 473 performs an XOR operation on the value stored in the register 450 and a next output of the key memory 425. The XOR-operated value is stored in a designated location of the key memory 425 again.

The control circuit 380 sequentially sets an address of the key memory 425 and a data path required for the round key operation according to a predetermined state degree.

As described above, an apparatus of a low power AES cryptographic circuit for an embedded system according to the present invention changes a performance order during a round operation of an AES encrypting algorithm and reduces a time consumed for performing an AES encrypting operation to improve performance. Also, the present invention reduces power consumed for moving data on a data bus by reducing all data required for performing an AES encrypting algorithm to an operation unit of a byte unit suitable for a low power structure. Also, the present invention minimizes change in data using registers in order to reduce power consumption caused by switching of an undesired circuit of each element block.

As described above, an apparatus of a low power AES cryptographic circuit for an embedded system according to the present invention is used for protecting a user's privacy under a wired/wireless data environment such as a U-work business, a U-city business, an RFID system, a wireless sensor network or a home network that recently develop. Also, the an apparatus of a low power AES cryptographic circuit is realized in low power and a small area suitable for an embedded system, and is capable of maintaining an encrypting performance of more than a predetermined level.

While the present invention has been shown and described in connection with the preferred embodiments, it will be apparent to those skilled in the art that modifications and variations can be made without departing from the spirit and scope of the invention as defined by the appended claims.

What is claimed is:

1. An apparatus for a low power AES (advanced encryption standard) cryptographic circuit for an embedded system, the apparatus comprising:
an interface circuit for inputting and outputting data and a control command in cooperation with a general purpose processor;
a code processing unit for performing a round operation in an operation order of an add round key operation, a sub byte key operation, a shift row operation, and a mix column operation;
a data memory for storing data input through the interface circuit and operation results processed at the code processing unit;
a data selecting unit for selecting data input/output to and from the code processing unit and a storing unit; and
a control unit for controlling the code processing unit, the storing unit, and the data selecting unit such that a round operation of a set round is repeatedly performed on data input from the interface circuit, and an add round key operation is performed on a shift row-operated result value and a secret key during a last round.

2. The apparatus of claim 1, wherein the code processing unit performs the round operation on data by a byte unit.

3. The apparatus of claim 1, wherein the code processing unit comprises:
an add round key circuit for performing an add round key operation on one of input data stored in the data memory and operation results of a previous round;
an S-box for performing a sub byte operation on operation results of the add round key circuit;
a shift row circuit for performing a shift row operation on operation results of the S-box; and
a mix column circuit for performing an mix column operation on operation results of the shift row circuit.

4. The apparatus of claim 3, further comprising:
a key memory for storing a secret key input from the interface circuit and a round key generated from the secret key, and providing key data required for an operation of the add round key circuit; and
a round key generating circuit for reading key data stored in the key memory to generate a round key used for each round operation of the code processing unit.

5. The apparatus of claim 4, wherein the round key generating circuit generates a round key of a next round using the S-box when a mix column operation is performed at the code processing unit.

6. The apparatus of claim 4, further comprising a register for temporarily storing one of intermediate results of the code processing unit and intermediate results of the round key generating circuit before storing it in one of the data memory and the key memory.

7. The apparatus of claim 6, wherein the shift row circuit is realized by generating a location movement when operation results of the S-box are stored in the register.

8. The apparatus of claim 7, wherein the S-box is realized as a combination circuit.

9. The apparatus of claim 8, wherein the mix column circuit is realized as a 32-bit shift register and a plurality of 8-bit XOR circuits.

10. The apparatus of claim 9, wherein the add round key circuit is realized as a first XOR operator performing an XOR-operation on outputs of the data memory and the key memory.

11. The apparatus of claim 10, wherein the round key generating circuit comprises:
a constant generator for generating a constant required for generating a round key defined in an AES cryptographic algorithm;
a second XOR operator for performing an XOR-operation on a result value of the S-box and a constant generated at the constant generator; and
a third XOR operator for performing an XOR operation on an operation result of the second XOR operator and a next output value of the key memory.

12. The apparatus of claim 11, wherein the data selecting unit comprises:
a first data selector for selecting one of input data input from the interface circuit, a result of the add round key operation, a result of the shift row operation, and a result of the mix column operation, to store the selected data in the data memory;
a second data selector for selecting one of key data input from the interface circuit and an operation result of the third XOR operator, to store the selected data in the key memory;
a third data selector for selecting one of a result of the add round key operation and an output value of the key memory, to apply the selected data to the S-box;
a fourth data selector for selecting one of an operation result of the S-box and an operation result of the second XOR operator to store the selected data in a register; and
a fifth data selector for selecting one of an operation result of the S-box and an output of the register to provide the selected data as a result of the shift row operation to the first data selector.

13. A method for a low power AES cryptographic circuit for an embedded system, the method comprising:
performing operations on data to be encrypted in an order of an add round key operation, a sub byte operation, a shift row operation, and a mix column operation;
performing operations on a result of a mix column operation of a previous round in an order of the add round key operation, the sub byte operation, and the shift row operation;
after the performing of the operations on the result of the mix column operation, checking whether a current round is a last round;
when the current round is not the last round as a result of the checking, performing operations again starting from the performing of the operations on the result of the mix column operation, after performing a mix column operation on a result of the performing of the operations on the result of the mix column operation;
when the current round is the last round as a result of the checking, performing an add round key operation that uses a secret key on a result of the performing of the operations on the result of the mix column operation; and
outputting, as encryption data, a result value of the performing of the add round key operation that uses the secret key.

14. The method of claim 13, wherein all of the add round key operation, the sub byte operation, and the shift row operation are performed during one clock cycle.

15. The method of claim 13, wherein the add round key operation, the sub byte operation, the shift row operation, and the mix column operation are performed on data by a byte unit.

16. The method of claim 15, wherein the mix column operation stores data by a 8-bit unit using a 32-bit shift register and an 8-bit XOR circuit, and moves to perform an operation at an 8 clock.
